(19) United States
(12) Patent Application Publication
(10) Pub. No.: US 2024/0062406 A1
(43) Pub. Date: Feb. 22, 2024

(54) INFORMATION PROCESSING APPARATUS, NON-TRANSITORY COMPUTER READABLE MEDIUM, AND METHOD

(71) Applicant: FUJIFILM Business Innovation Corp., Tokyo (JP)

(72) Inventors: Aya KUWANO, Kanagawa (JP); Eri SATO, Kanagawa (JP); Mitsuru SATO, Kanagawa (JP); Kohei KAIBARA, Kanagawa (JP)

(73) Assignee: FUJIFILM Business Innovation Corp., Tokyo (JP)

(21) Appl. No.: 18/181,709

(22) Filed: Mar. 10, 2023

(30) Foreign Application Priority Data
Aug. 19, 2022 (JP) 2022-131329

(51) Int. Cl. G06T 7/70

(52) U.S. Cl. CPC G06T 7/70; G06T 2207/30176; G06T 2207/30204

(57) ABSTRACT

An information processing apparatus includes a processor configured to: acquire captured data of an image captured surface that is captured by an image capturer, a document, a first definition portion in which a first process that is performed on image data of an image of the document is defined, and a second definition portion in which a second process that differs from the first process is defined being placed on the image captured surface; and perform the first process that is defined in the first definition portion and the second process that is defined in the second definition portion on the image data of the document that is contained in the captured data that is acquired.

### CROSS-REFERENCE TO RELATED APPLICATIONS

This application is based on and claims priority under 35 USC 119 from Japanese Patent Application No. 2022-131329 filed Aug. 19, 2022.

### BACKGROUND

### (i) Technical Field

The present disclosure relates to an information processing apparatus, a non-transitory computer readable medium, and a method.

### (ii) Related Art

A technique disclosed in Japanese Patent No. 6019872 is to reduce difficulty in preparing automatic processing after a large number of objects to be used as data are captured.

### SUMMARY

A known technique is to detect multiple markers that serve as definition portions in the image data of an image of a document that is captured by an image capturer and to extract trimmed regions that are surrounded by the detected multiple markers. As for the technique, however, a trimming process, that is, an image process is equally defined in each marker, and another process cannot be performed although the image process is performed by using the detected marker.

Aspects of non-limiting embodiments of the present disclosure relate to performing different processes that are defined in multiple definition portions.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: acquire captured data of an image captured surface that is captured by an image capturer, a document, a first definition portion in which a first process that is performed on image data of an image of the document is defined, and a second definition portion in which a second process that differs from the first process is defined being placed on the image captured surface; and perform the first process that is defined in the first definition portion and the second process that is defined in the second definition portion on the image data of the document that is contained in the captured data that is acquired.

### BRIEF DESCRIPTION OF THE DRAWINGS

An exemplary embodiment of the present disclosure will be described in detail based on the following figures, wherein:

FIG. 1 is a perspective view of an example of the entire structure of an image processing apparatus;

FIG. 2 is a block diagram of an example of the hardware configuration of an electrical system of the image processing apparatus;

FIG. 3 schematically illustrates an example of the structure of a marker information database;

FIG. 4 is a flowchart illustrating the flow of a performing process that is performed by the image processing apparatus;

FIG. 5 illustrates a first placement example for a document and markers regarding the image processing apparatus;

FIG. 6 illustrates a second placement example for the document and the markers regarding the image processing apparatus;

FIG. 7 illustrates a third placement example for the document and the markers regarding the image processing apparatus;

FIG. 8 illustrates a fourth placement example for the document and the markers regarding the image processing apparatus;

FIG. 9 illustrates a fifth placement example for the document and the markers regarding the image processing apparatus;

FIG. 10 illustrates a sixth placement example for the document and the markers regarding the image processing apparatus;

FIG. 11 illustrates a seventh placement example for the document and the markers regarding the image processing apparatus; and

FIG. 12 illustrates an eighth placement example for the document and the markers regarding the image processing apparatus.

### DETAILED DESCRIPTION

An exemplary embodiment of the present disclosure will hereinafter be described in detail with reference to the drawings. In an example described according to the present exemplary embodiment, an information processing apparatus that uses a technique according to the present disclosure is used for an image processing apparatus that is disposed in an office and that includes a document camera. A target to which the technique according to the present disclosure is applied is not limited to the office but may be a target at any location such as a school or a household, provided that the image processing apparatus is installable at the location. A target to which the information processing apparatus that uses the technique according to the present disclosure is applied is not limited to the image processing apparatus but may be, for example, an image reading apparatus that reads an image or an image transmitting apparatus that transmits a read image to another apparatus.

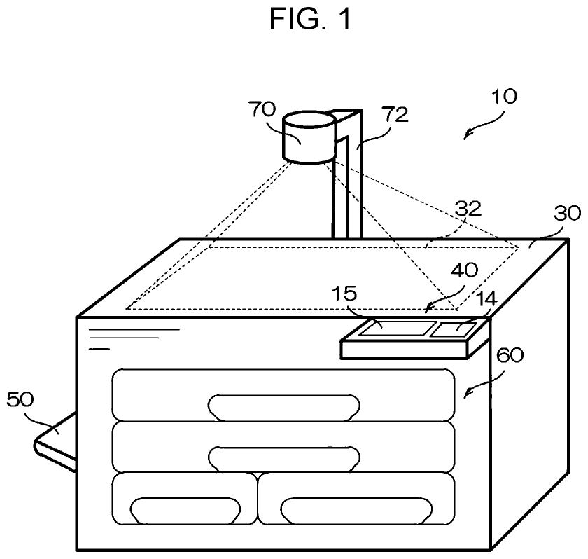

The structure of an image processing apparatus 10 according to the present exemplary embodiment will now be described with reference to FIG. 1. FIG. 1 is a perspective view of an example of the entire structure of the image processing apparatus 10 according to the present exemplary embodiment.

As illustrated in FIG. 1, the image processing apparatus 10 according to the present exemplary embodiment includes a document table 30 that has an upper surface on which a document is placed, a user interface unit (referred to below as a “UI unit”) 40 for displaying various kinds of information and for inputting various kinds of information, a tray 50 onto which paper with a formed image is discharged, and a paper feeding unit 60 that feeds various kinds of paper.

The image processing apparatus 10 according to the present exemplary embodiment also includes a document camera 70 that is capable of capturing an image on the upper surface of the document table 30. A first end portion of an arm 72 is fixed to the rear of the document table 30, and the document camera 70 according to the present exemplary embodiment is disposed on a second end portion of the arm 72 and is positioned such that the angle of view for image capturing substantially matches a document placement region 32 of the document table 30. The document camera 70 is an example of an “image capturer”. The document placement region 32 is an example of an “image captured surface”.

According to the present exemplary embodiment, the document camera 70 captures a color image but is not limited thereto. For example, the document camera 70 may capture a monochrome image or a grayscale image.

The UI unit 40 according to the present exemplary embodiment includes an input unit 14 that includes various switches and a display 15 that includes, for example, a liquid-crystal display. The display 15 according to the present exemplary embodiment is a so-called touch screen display that includes a touch screen where a front surface of the display is optically transparent.

According to the present exemplary embodiment, the image processing apparatus 10 is a digital multifunction peripheral that has an image printing function, an image reading function, an image transmitting function, and so on. However, the image processing apparatus 10 is not limited thereto, provided that the image processing apparatus 10 has at least the image reading function.

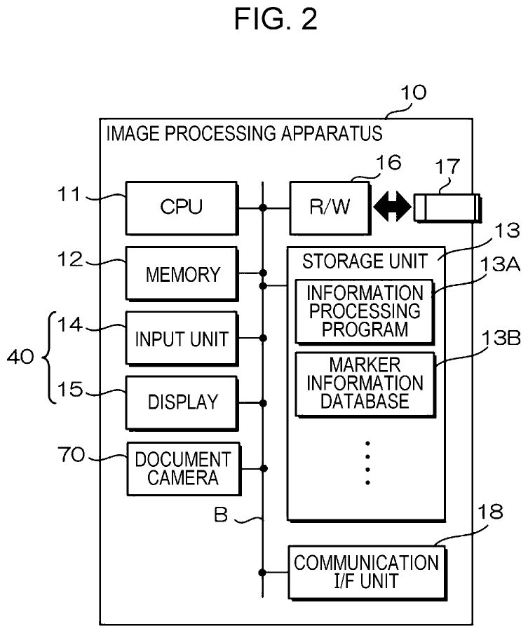

The structure of an electrical system of the image processing apparatus 10 according to the present exemplary embodiment will now be described with reference to FIG. 2. FIG. 2 is a block diagram of an example of the hardware configuration of the electrical system of the image processing apparatus 10 according to the present exemplary embodiment.

As illustrated in FIG. 2, the image processing apparatus 10 according to the present exemplary embodiment includes a central processing unit (CPU) 11 that is an example of a processor, a memory 12 that serves as a temporary storage area, a non-volatile storage unit 13, and the UI unit 40 that includes the input unit 14 and the display 15 described above. The image processing apparatus 10 according to the present exemplary embodiment also includes a medium reader-writer device (R/W) 16, a communication interface (UF) unit 18, and the document camera 70 described above. The CPU 11, the memory 12, the storage unit 13, the UI unit 40, the medium reader-writer device 16, the communication OF unit 18, and the document camera 70 are connected to each other via a bus B. The medium reader-writer device 16 reads information that is written in a recording medium 17 and writes information to the recording medium 17.

Examples of the storage unit 13 according to the present exemplary embodiment include a hard disk drive (HDD), a solid state drive (SSD), and a flash memory. The storage unit 13 stores an information processing program 13A. The recording medium 17 to which the information processing program 13A is written is connected to the medium reader-writer device 16, the medium reader-writer device 16 reads the information processing program 13A from the recording medium 17, and the information processing program 13A is stored (installed) in the storage unit 13. The CPU 11 loads the information processing program 13A from the storage unit 13 into the memory 12 and sequentially performs processes that are included in the information processing program 13A.

The storage unit 13 stores a marker information database 13B. The marker information database 13B will be described in detail later.

According to the present exemplary embodiment, a barcode, a two-dimensional code, or a marker that uses a mechanically readable code such as a pattern image that is printed in accordance with a predetermined rule is used as a marker. According to the present exemplary embodiment, the mechanically readable code is a code that contains information that represents the content of a process that is performed on the image data of an image of the document. The marker is not limited to these forms but may be a marker that does not contain a code such as the mechanically readable code. In this case, the content of the process described above may be defined depending on a difference in appearance such as the shape, dimensions, and color of the marker. Even in the case where the mechanically readable code is used as the marker, the content of the process may be defined depending on the kind of the color of the marker.

According to the present exemplary embodiment, the process described above is defined in the marker, and examples thereof include an image process, an output process related to the output of the image data, and a setting process related to various settings. Examples of the image process include a cutting process, a mask process, an optical character recognition or reader (OCR) process, and a processing process. Examples of the output process include a transfer process of transferring the image data to, for example, a server apparatus via a network or mail transmission for an attachment in an electronic mail, a print (image formation) process, and a scanning (image reading) process. Examples of the setting process include a process of specifying the presence or absence of a next document and a process of specifying a page.

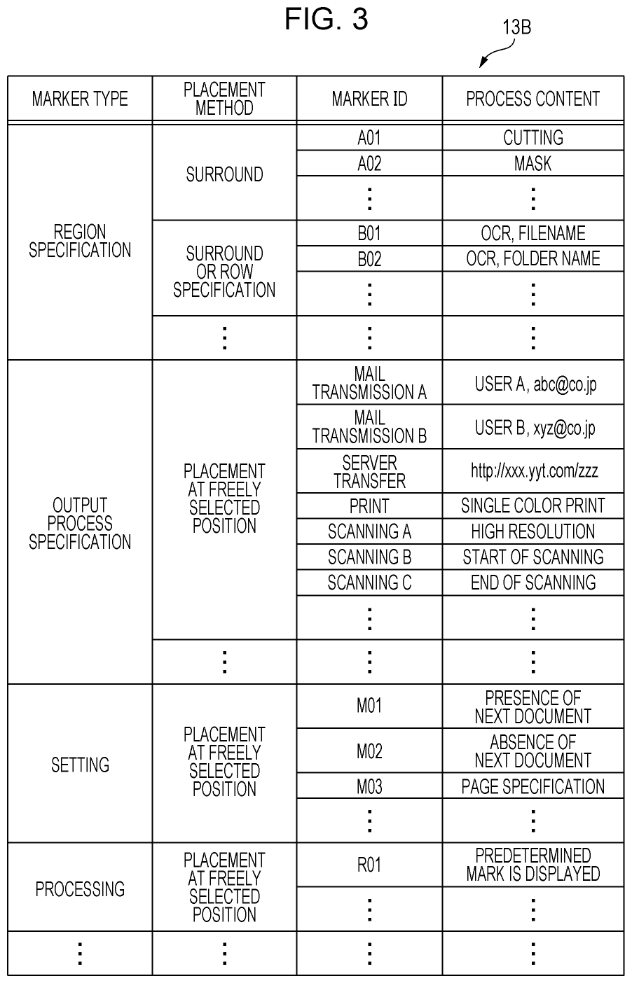

The marker information database 13B according to the present exemplary embodiment will now be described with reference to FIG. 3. FIG. 3 schematically illustrates an example of the structure of the marker information database 13B according to the present exemplary embodiment.

The marker information database 13B according to the present exemplary embodiment is a database in which information related to the marker described above is registered. As for the marker information database 13B according to the present exemplary embodiment, as illustrated in FIG. 3, pieces of information about a marker type, a placement method, a marker ID (identification), and a process content, for example, are associated with each other and stored therein.

The marker type is information that represents the type of the marker. The placement method is information that represents a method of placing the marker. The marker ID is information that is added in advance so as to differ depending on the type of the marker and the process content in order to identify the corresponding marker. The process content is information that represents the content of the process that is defined in the corresponding marker.

In an example illustrated in FIG. 3, for example, as for a marker to which “A01” is added as the marker ID, information is registered such that the marker type is region specification, the placement method is a method of surrounding a region to be processed, and the content of the process is image cutting. In this way, the type of the marker, the placement method, and the content of the process that are registered in the database in advance may be grasped by reference to the marker information database 13B.

That is, according to the exemplary embodiment, the marker does not contain information that represents the content of the process itself, but the marker contains information that represents the marker ID. According to the exemplary embodiment, the information that represents the content of the process corresponding to the marker ID is acquired from the marker information database 13B, and the content of the corresponding process is identified. However, this is not a limitation, and the marker may contain the information that represents the content of the process itself. In this case, the marker information database 13B is not needed.

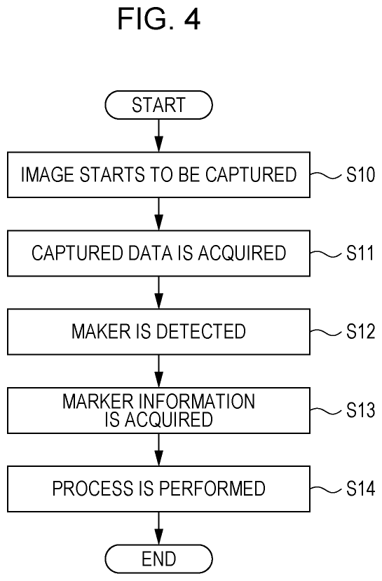

The flow of the process that is performed by the image processing apparatus 10 will now be described with reference to FIG. 4. FIG. 4 is a flowchart illustrating the flow of a performing process that is performed by the image processing apparatus 10 according to the present exemplary embodiment to perform the process that is defined in the marker. The CPU 11 reads and loads the information processing program 13A from the storage unit 13 into the memory 12 and runs the information processing program 13A, and consequently, the performing process is performed. In the case where a user performs a predetermined operation by using the UI unit 40, the CPU 11 starts the performing process. Before the predetermined operation is performed, the user places the document in the document placement region 32 and places a marker (referred to below as an “image process marker”) in which the image process is defined and a marker (referred to below as an “output process marker”) in which the output process is defined. The timing with which the performing process starts is not limited by the operation of the user. For example, the performing process may start in the case where a predetermined time has elapsed after the image process marker and the output process marker are placed. The image process marker is an example of a “first definition portion”. The output process marker is an example of a “second definition portion”. In a conceivable method of identifying a predetermined time after the image process marker and the output process marker described above are placed, for example, an image of the document placement region 32 that is continuously captured by the document camera 70 is acquired, and the predetermined time is identified when the predetermined time has elapsed after the image represents a rest state. At this time, the image that is acquired by the CPU 11 may have resolution lower than the resolution of the image that is captured to identify the process that is defined in, for example, the image process marker or the output process marker regarding the image data of the document.

At a step S10 illustrated in FIG. 4, the CPU 11 instructs the document camera 70 to capture the image, and the image of the document placement region 32 starts to be captured. The flow proceeds to a step S11.

At the step S11, the CPU 11 acquires the captured data of the document placement region 32 that is captured by the document camera 70 at the step S10. The flow proceeds to a step S12.

At the step S12, the CPU 11 detects the image of the marker in an image that is represented by the captured data that is acquired at the step S11. The flow proceeds to a step S13. For example, the CPU 11 uses a known pattern matching technique to detect the image of the marker.

At the step S13, the CPU 11 identifies the marker ID that is represented by the marker that is detected at the step S12 and acquires information corresponding to the identified marker ID from the marker information database 13B. The flow proceeds to a step S14.

At the step S14, the CPU 11 performs the process that is defined in the marker that is detected at the step S12. At this time, the CPU 11 performs the output process after the image process is performed. This is the end of the performing process.

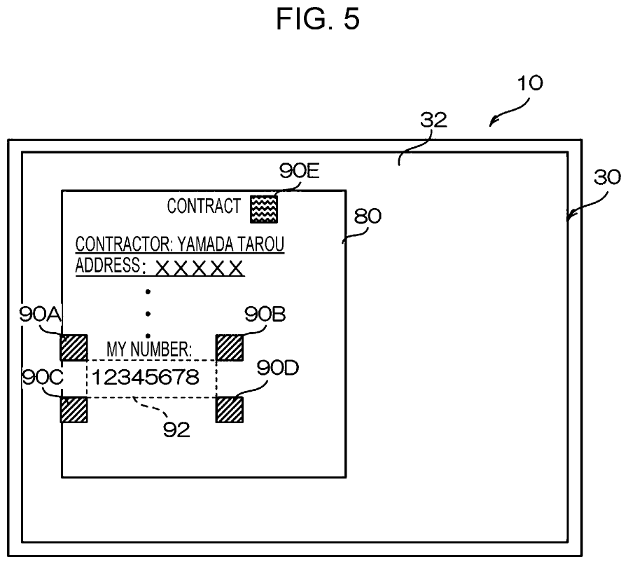

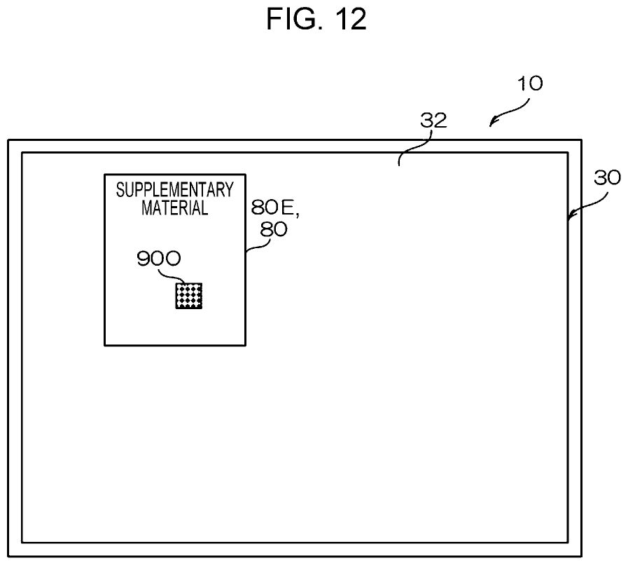

Placement examples for the document and the marker regarding the image processing apparatus 10 will now be described with reference to FIG. 5 and FIG. 12. FIG. 5 illustrates a first placement example for a document 80 and markers 90 regarding the image processing apparatus 10 according to the present exemplary embodiment.

As for the image processing apparatus 10 according to the present exemplary embodiment, as illustrated in FIG. 5, the user places the document 80 and the markers 90 at freely selected positions in the document placement region 32 of the document table 30 when the performing process illustrated in FIG. 4 is started.

Markers 90A and 90B and the other markers illustrated in FIG. 5 use different mechanically readable codes as described above. In the following description, the marker 90A, the marker 90B, and the other markers are correctively referred to as the “markers 90” in the case where these are not distinguished in the description.

According to the present exemplary embodiment, the markers 90 are classified into types such as the image process marker, the output process marker, and a setting marker and are prepared in advance as described above. At least the image process marker and the output process marker have different appearances. According to the present exemplary embodiment, the image process marker and the output process marker have different colors. This is not a limitation. The appearances may differ depending on a difference in the shape, dimensions, and figure of each marker.

In an example illustrated in FIG. 5, the image process markers 90A and 90B and image process markers 90C and 90D in which the mask process is defined as the image process are placed so as to surround the numeral of my number on the document 80 that is placed in the document placement region 32. In the example illustrated in FIG. 5, an output process marker 90E in which the transfer process is defined as the output process is placed on an upper portion of the document 80.

In this case, the CPU 11 of the image processing apparatus 10 performs the output process on the image data of the document 80 on which the image process is performed. In the example illustrated in FIG. 5, for this reason, the CPU 11 identifies the type of each of the markers 90 that are placed in the document placement region 32 and subsequently identifies a marker ID “A02” in the images of the image process markers 90A to 90D. The CPU 11 refers the marker information database 13B (see FIG. 3) and determines that the content of the process corresponding to the marker ID “A02” is the “mask process”. In the example illustrated in FIG. 5, the mask process is consequently performed on a region 92 to be processed that is surrounded by the image process markers 90A to 90D regarding the image data of the document 80.

In the example illustrated in FIG. 5, the CPU 11 subsequently identifies a marker ID “server transfer” in the image of the output process marker 90E. The CPU 11 refers the marker information database 13B (see FIG. 3) and determines that the content of the process corresponding to the marker ID “server transfer” is a “process of transferring the image data to an address of http://xxx.yyt.com/zzz”. In the example illustrated in FIG. 5, the image data of the document 80 on which the mask process described above is performed is consequently transferred to the server that is defined in the output process marker 90E. In this way, the image processing apparatus 10 may perform the image process and the output process in this order on the image data of the document 80.

As for the image processing apparatus 10, the CPU 11 acquires the captured data of the document placement region 32 that is captured by the document camera 70 as described above. The CPU 11 performs the image process that is defined in the image process marker and the output process that is defined in the output process marker on the image data of the document 80 that is contained in the captured data that is acquired.

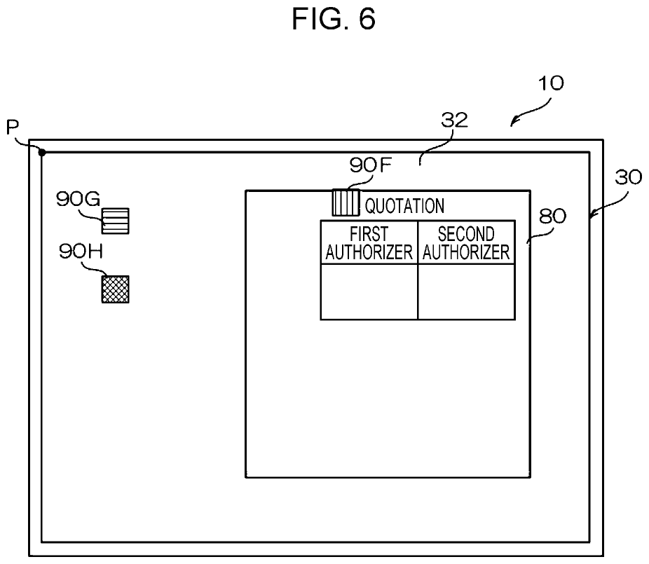

FIG. 6 illustrates a second placement example for the document 80 and the markers 90 regarding the image processing apparatus 10 according to the present exemplary embodiment.

In an example illustrated in FIG. 6, an image process marker 90F in which an OCR process is defined as the image process is placed on the left of characters “QUOTATION” on the document 80 that is placed in the document placement region 32. In the example illustrated in FIG. 6, an output process marker 90G and an output process marker 90H in which the transfer processes are defined as the output processes are placed in the document placement region 32 outside the document 80. Of the output process marker 90G and the output process marker 90H, the output process marker 90G is placed nearest to a reference position P at an upper left corner of the document placement region 32. In this way, a position at which each output process marker is placed is not limited provided that the position is in the document placement region 32, and the output process marker may be placed outside or inside the document 80.

The CPU 11 acquires position information about the multiple output process markers that are placed in the document placement region 32. The CPU 11 controls the order in which multiple output processes are performed depending on the acquired position information. For example, the CPU 11 sequentially performs the multiple output processes that are defined in the multiple output process markers in order of increasing distance from the reference position P in the document placement region 32. According to the present exemplary embodiment, the position information is information that represents coordinates on a two-dimensional coordinate system the origin of which is located at the reference position P.

In the example illustrated in FIG. 6, the CPU 11 identifies the type of each of the markers 90 that are placed in the document placement region 32 and subsequently identifies a marker ID “B01” in the image of the image process marker 90F accordingly. The CPU 11 refers the marker information database 13B (see FIG. 3) and determines that the content of the process corresponding to the marker ID “B01” is a “process of performing the OCR process and setting a filename to the extracted characters. In the example illustrated in FIG. 6, the OCR process is consequently performed on the characters that are located on the right of the image process marker 90F regarding the image data of the document 80, and the filename of the image data is set to the result of the OCR process (such as characters “quotation”).

In the example illustrated in FIG. 6, the CPU 11 subsequently identifies a marker ID “mail transmission A” in the image of the output process marker 90G. The CPU 11 refers the marker information database 13B (see FIG. 3) and determines that the content of the process corresponding to the marker ID “mail transmission A” is a “process of transmitting the image data to the address “abc@co.jp” of a user A. In the example illustrated in FIG. 6, the CPU 11 identifies a marker ID “mail transmission B” in the image of the output process marker 90H. The CPU 11 refers the marker information database 13B (see FIG. 3) and determines that the content of the process corresponding to the marker ID “mail transmission B” is a “process of transmitting the image data to the address “xyz@co.jp” of a user B.

In the example illustrated in FIG. 6, the image data of the document 80 on which the OCR process described above is performed is consequently transmitted to the address of the user A that is defined in the output process marker 90G. In this case, the CPU 11 transmits the image data to which identification information that enables the image data to be identified is added. Subsequently, the user A performs a predetermined process (such as electronic signing) on the acquired image data and subsequently transmits the image data to the image processing apparatus 10. The CPU 11 that acquires the image data from the user A transmits the image data to the address of the user B that is defined in the output process marker 90H. Subsequently, the user B performs a predetermined process (such as electronic signing) on the acquired image data and subsequently transmits the image data to the image processing apparatus 10.

With the configuration described above, the image processing apparatus 10 may control the order in which the multiple output processes are performed without containing the order in which the output processes are performed in the output process markers. In addition, the image processing apparatus 10 may control the order in which the multiple output processes are performed with the reference position P in the document placement region 32 being the origin.

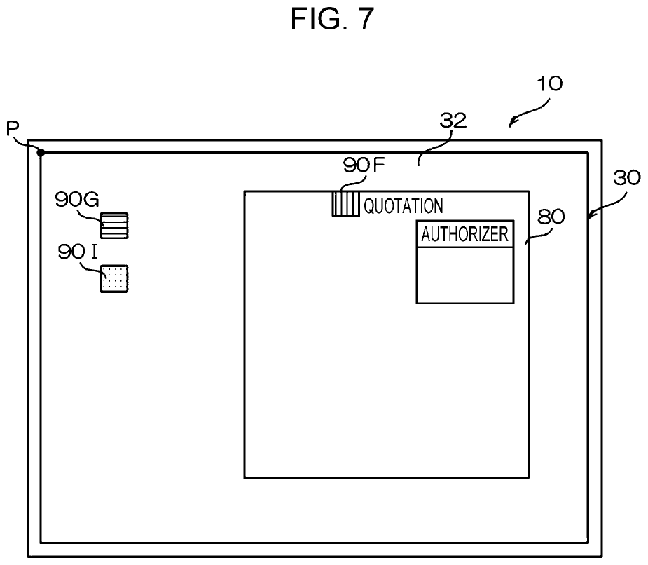

FIG. 7 illustrates a third placement example for the document 80 and the markers 90 regarding the image processing apparatus 10 according to the present exemplary embodiment.

In an example illustrated in FIG. 7, the image process marker 90F in which the OCR process is defined as the image process is placed on the left of the characters “QUOTATION” on the document 80 that is placed in the document placement region 32. In the example illustrated in FIG. 7, the output process marker 90G in which the transfer process is defined as the output process and an output process marker 90I in which a print process is defined as the output process are placed in the document placement region 32 outside the document 80. Of the output process marker 90G and the output process marker 90I, the output process marker 90G is placed nearest to the reference position P.

In the example illustrated in FIG. 7, the CPU 11 identifies the type of each of the markers 90 that are placed in the document placement region 32 and subsequently identifies the marker ID “B01” in the image of the image process marker 90F. The CPU 11 refers the marker information database 13B (see FIG. 3) and determines that the content of the process corresponding to the marker ID “B01” is the “process of performing the OCR process and setting the filename to the extracted characters. In the example illustrated in FIG. 7, the OCR process is consequently performed on the characters that are located on the right of the image process marker 90F regarding the image data of the document 80, and the filename of the image data is set to the result of the OCR process (such as the characters “quotation”).

In the example illustrated in FIG. 7, the CPU 11 identifies the marker ID “mail transmission A” in the image of the output process marker 90G. The CPU 11 refers the marker information database 13B (see FIG. 3) and determines that the content of the process corresponding to the marker ID “mail transmission A” is the “process of transmitting the image data to the address “abc@co.jp” of the user A. In the example illustrated in FIG. 7, the CPU 11 identifies a marker ID “print” in the image of the output process marker 90I. The CPU 11 refers the marker information database 13B (see FIG. 3) and determines that the content of the process corresponding to the marker ID “print” is a “process of outputting a single color print”.

In the example illustrated in FIG. 7, the image data of the document 80 on which the OCR process described above is performed is consequently transmitted to the address of the user A that is defined in the output process marker 90G. In this case, the CPU 11 transmits the image data to which the identification information that enables the image data to be identified is added. Subsequently, the user A performs the predetermined process (such as electronic signing) on the acquired image data and subsequently transmits the image data to the image processing apparatus 10. The CPU 11 that acquires the image data from the user A outputs the image data as a single color print, based on the content of the print process that is defined in the output process marker 90I.

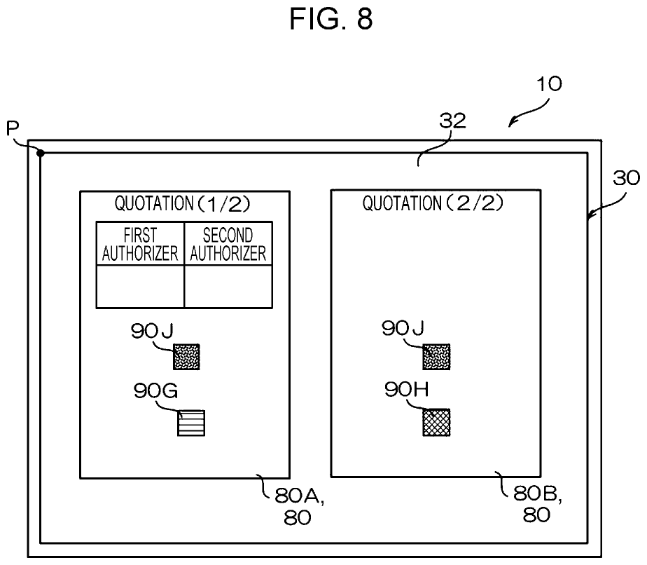

FIG. 8 illustrates a fourth placement example for the document 80 and the markers 90 regarding the image processing apparatus 10 according to the present exemplary embodiment.

In an example illustrated in FIG. 8, one of image process markers 90J in which the processing process is defined as the image process and the output process marker 90G in which the transfer process is defined as the output process are placed on a document 80A that is placed on a left-hand portion in the document placement region 32. In the example illustrated in FIG. 8, the other image process marker 90J in which the processing process is defined as the image process and the output process marker 90H in which the transfer process is defined as the output process are placed on a document 80B that is placed on a right-hand portion in the document placement region 32. Of the output process marker 90G and the output process marker 90H, the output process marker 90G is placed nearest to the reference position P.

In the example illustrated in FIG. 8, the CPU 11 identifies the type of each of the markers 90 that are placed in the document placement region 32 and subsequently identifies a marker ID “R01” in the images of the image process markers 90J. The CPU 11 refers the marker information database 13B (see FIG. 3) and determines that the content of the process corresponding to the marker ID “R01” is a “process of displaying a predetermined mark in the image data”. In the example illustrated in FIG. 8, the processing process that is defined in the image process markers 90J that are placed on the document 80A and the document 80B is consequently performed on the image data of the document 80A and the document 80B. For example, it is defined in the image process markers 90J that the processing process is the process of displaying the predetermined mark (such as characters “attention”) in the image data.

In the example illustrated in FIG. 8, the CPU 11 subsequently identifies the marker ID “mail transmission A” in the image of the output process marker 90G. The CPU 11 refers the marker information database 13B (see FIG. 3) and determines that the content of the process corresponding to the marker ID “mail transmission A” is the “process of transmitting the image data to the address “abc@co.jp” of the user A. In the example illustrated in FIG. 8, the CPU 11 identifies the marker ID “mail transmission B” in the image of the output process marker 90H. The CPU 11 refers the marker information database 13B (see FIG. 3) and determines that the content of the process corresponding to the marker ID “mail transmission B” is the “process of transmitting the image data to the address “xyz@co.jp” of the user B.

In the example illustrated in FIG. 8, the image data of the document 80A and the document 80B on which the processing process described above is performed is consequently transmitted to the address of the user A that is defined in the output process marker 90G and the address of the user B that is defined in the output process marker 90H. In this case, as for a terminal of the user A that acquires the image data, the document 80A is displayed as the first page, and as for a terminal of the user B that acquires the image data, the document 80B is displayed as the first page.

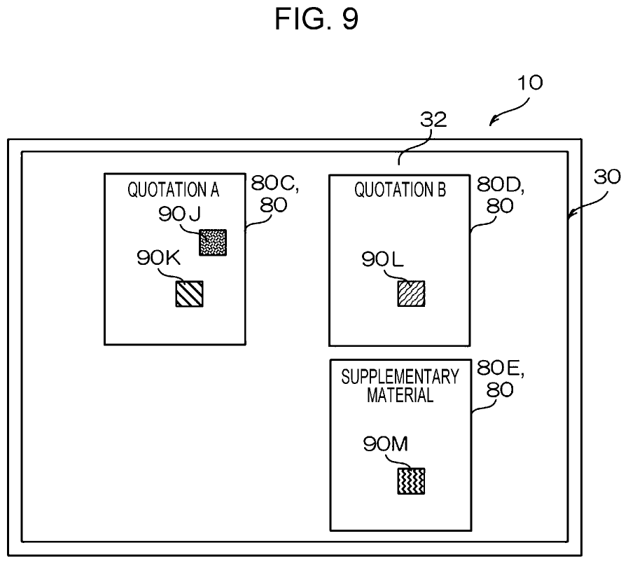

FIG. 9 illustrates a fifth placement example for the document 80 and the markers 90 regarding the image processing apparatus 10 according to the present exemplary embodiment.

In an example illustrated in FIG. 9, the image process marker 90J in which the processing process is defined as the image process and an output process marker 90K in which the scanning process is defined as the output process are placed on a document 80C that is placed in the document placement region 32. In the example illustrated in FIG. 9, a setting marker 90L for specifying the presence of a next document is placed on a document 80D that is placed on the right of the document 80C in the document placement region 32, and a setting marker 90M for specifying the absence of a next document is placed on a document 80E that is placed below the document 80D in the document placement region 32.

In the example illustrated in FIG. 9, the CPU 11 identifies the type of each of the markers 90 that are placed in the document placement region 32 and subsequently identifies the marker ID “R01” in the image of the image process marker 90J. The CPU 11 refers the marker information database 13B (see FIG. 3) and determines that the content of the process corresponding to the marker ID “R01” is the “process of displaying the predetermined mark in the image data”. In the example illustrated in FIG. 9, the processing process that is defined in the image process marker 90J that is placed on the document 80C is consequently performed on the image data of the document 80C, the document 80D, and the document 80E.

In the example illustrated in FIG. 9, the CPU 11 subsequently identifies a marker ID “scanning A” in the image of the output process marker 90K. The CPU 11 refers the marker information database 13B (see FIG. 3) and determines that the content of the process corresponding to the marker ID “scanning A” is a “process of scanning at a high resolution”. In the example illustrated in FIG. 9, the CPU 11 identifies a marker ID “M01” in the image of the setting marker 90L. The CPU 11 refers the marker information database 13B (see FIG. 3) and determines that the content of the process corresponding to the marker ID “M01” is the “process of specifying the presence of a next document”. In the example illustrated in FIG. 9, the CPU 11 identifies a marker ID “M02” in the image of the setting marker 90M. The CPU 11 refers the marker information database 13B (see FIG. 3) and determines that the content of the process corresponding to the marker ID “M02” is the “process of specifying the absence of a next document”.

In the example illustrated in FIG. 9, the scanning process that is defined in the output process marker 90K is consequently performed on the image data of the document 80C, the document 80D, and the document 80E on which the processing process described above is performed. In this case, the CPU 11 checks the markers 90 that are placed on the document 80D and the document 80E and performs the processes that are defined in the markers 90. As a result, in the example illustrated in FIG. 9, the image data of the document 80C, the document 80D, and the document 80E is scanned such that the document 80C is scanned as the first page, the document 80D is scanned as the second page, and the document 80E is scanned as the third page.

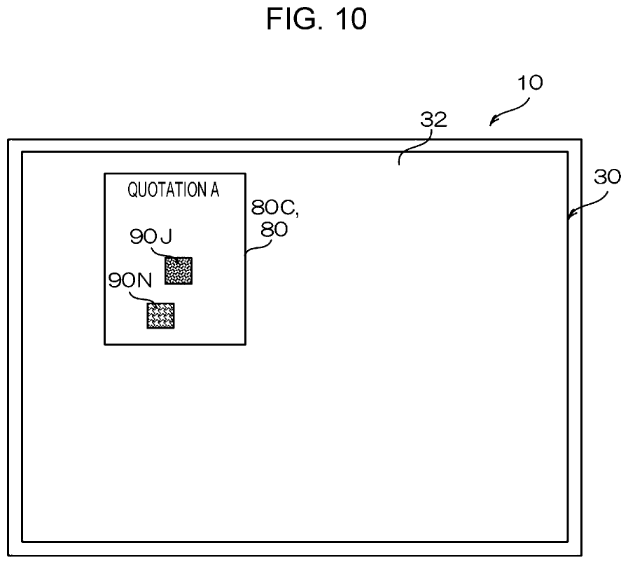

FIG. 10 illustrates a sixth placement example for the document 80 and the markers 90 regarding the image processing apparatus 10 according to the present exemplary embodiment.

In an example illustrated in FIG. 10, the image process marker 90J in which the processing process is defined as the image process and an output process marker 90N in which the scanning process is defined as the output process are placed on the document 80C that is placed in the document placement region 32.

In the example illustrated in FIG. 10, the CPU 11 identifies the type of each of the markers 90 that are placed in the document placement region 32 and subsequently identifies the marker ID “R01” in the image of the image process marker 90J. The CPU 11 refers the marker information database 13B (see FIG. 3) and determines that the content of the process corresponding to the marker ID “R01” is the “process of displaying the predetermined mark in the image data”. In the example illustrated in FIG. 10, the processing process that is defined in the image process marker 90J is consequently performed on the image data of the document 80C.

In the example illustrated in FIG. 10, the CPU 11 subsequently identifies a marker ID “scanning B” in the image of the output process marker 90N. The CPU 11 refers the marker information database 13B (see FIG. 3) and determines that the content of the process corresponding to the marker ID “scanning B” is a “process of starting scanning”. For example, it is defined in the output process marker 90N that the process of scanning is regularly performed to acquire a single piece of data at predetermined time intervals. For this reason, in the example illustrated in FIG. 10, the document 80C is scanned as the first page regarding the image data of the document 80C, the document 80D, and the document 80E.

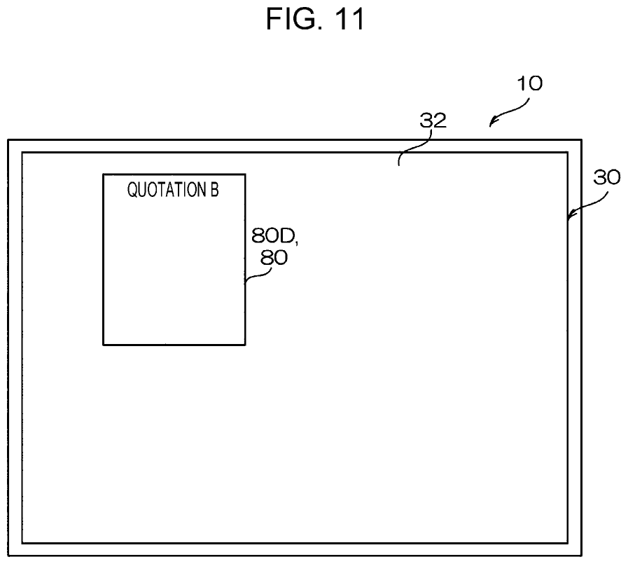

FIG. 11 illustrates a seventh placement example for the document 80 and the markers 90 regarding the image processing apparatus 10 according to the present exemplary embodiment.

In an example illustrated in FIG. 11, the user removes the document 80C, the image process marker 90J, and the output process marker 90N illustrated in FIG. 10 and places the document 80D in the document placement region 32 instead. In this case, the CPU 11 performs the scanning process, based on a scanning timing that is defined in the output process marker 90N that is placed in the document placement region 32 in FIG. 10. As a result, in the example illustrated in FIG. 11, the document 80D is scanned as the second page regarding the image data of the document 80C, the document 80D, and the document 80E.

FIG. 12 illustrates an eighth placement example for the document 80 and the markers 90 regarding the image processing apparatus 10 according to the present exemplary embodiment.

In an example illustrated in FIG. 12, the user removes the document 80D illustrated in FIG. 11 and places the document 80E and an output process marker 90O in which the scanning process is defined as the output process in the document placement region 32 instead.

In the example illustrated in FIG. 12, the CPU 11 identifies a marker ID “scanning C” in the image of the output process marker 90O. The CPU 11 refers the marker information database 13B (see FIG. 3) and determines that the content of the process corresponding to the marker ID “scanning C” is a “process of ending the process of scanning in progress”. In this case, the CPU 11 performs the scanning process such that the document 80E is scanned as the third page, based on the scanning timing that is defined in the output process marker 90N that is placed in the document placement region 32 in FIG. 10 and ends the scanning process. As a result, in the examples illustrated in FIG. 10 to FIG. 12, the image data of the document 80C, the document 80D, and the document 80E is scanned such that the document 80C is scanned as the first page, the document 80D is scanned as the second page, and the document 80E is scanned as the third page.

### Others

According to the exemplary embodiment described above, the region 92 to be processed is rectangular (see FIG. 5). However, the shape of the region 92 to be processed is not limited but may be a triangular shape, a trapezoidal shape, a polygonal shape such as the shape of a pentagon or more, or a circular shape.

In the description according to the exemplary embodiment described above, the document camera 70 is capable of capturing the image on the upper surface of the document table 30 but is not limited thereto. The process according to the exemplary embodiment described above may be performed on captured data that is captured by a camera that is included in, for example, a smartphone or a laptop computer.

According to the exemplary embodiment described above, the appearances of the multiple output process markers that are placed in the document placement region 32 may differ from each other and the contents of the output processes that are defined on the surfaces of the multiple output process markers may be displayed. For example, characters “transfer” or “print”, for example, may be displayed on the surfaces of the output process markers to display the contents of the output processes, or predetermined marks may be displayed on the surfaces of the output process markers to display the contents of the output processes. In this way, the image processing apparatus 10 may allow the user to recognize the output process markers more readily than the case where the contents of the output processes that are defined on the surfaces of the output process markers are not displayed. In this case, the characters “transfer” or “print” that are displayed on the surfaces of the output process markers are not targets for the image process or the processing process that is performed on the image data of the document. For example, the characters are removed from the captured data that is captured by the document camera 70 or excluded from targets to be extracted in the OCR process.

According to the exemplary embodiment described above, the document may be writing on which only a character is written, writing on which only an image is displayed, or writing that is created by using a combination of a character, an image, and a symbol.

According to the exemplary embodiment described above, the reference position P is at the upper left corner of the document placement region 32 but is not limited thereto. The reference position P may be another position such as the position of a lower left corner, an upper right corner, or a lower right corner of the document placement region 32.

According to the exemplary embodiment described above, the CPU 11 may have a function of correcting the image data of the document 80 that is placed in the document placement region 32. For example, in the case where the position or the inclination of the document 80 in the document placement region 32 changes before or after the markers 90 are placed, it is thought that the CPU 11 corrects the change.

According to the exemplary embodiment described above, the CPU 11 may acquire captured data with the markers 90 placed in the document placement region 32 and captured data with no markers 90 placed in the performing process illustrated in FIG. 4. For example, in the case where it is determined that the markers 90 conceal the content of the document 80, the CPU 11 may give an instruction for scanning the document 80 with no markers 90 placed.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus includes: a processor configured to: acquire captured data of an image captured surface that is captured by an image capturer, a document, a first definition portion in which a first process that is performed on image data of an image of the document is defined, and a second definition portion in which a second process that differs from the first process is defined being placed on the image captured surface; and perform the first process that is defined in the first definition portion and the second process that is defined in the second definition portion on the image data of the document that is contained in the captured data that is acquired.

(((2)))

As for the information processing apparatus according to (((1))), the first process is an image process, and the second process is an output process related to an output of the image data, and the processor is configured to: perform the second process on the image data of the document on which the first process is performed.

(((3)))

As for the information processing apparatus according to (((2))), the processor is configured to: acquire position information about a plurality of the second definition portions that is placed on the image captured surface; and control an order in which a plurality of the second processes is performed depending on the position information that is acquired.

(((4)))

As for the information processing apparatus according to (((3))), the processor is configured to: sequentially perform the plurality of the second processes each of which is defined in a corresponding one of the plurality of the second definition portions in order of increasing distance from a reference position on the image captured surface.

(((5)))

As for the information processing apparatus described in any one of (((1))) to (((4))), the first definition portion and the second definition portion have different appearances.

(((6)))

As for the information processing apparatus according to (((5))), a plurality of the second definition portions that is placed on the image captured surface has different appearances, and a content of the second process that is defined on a surface of each of the plurality of the second definition portions is displayed.

(((7)))

An information processing program causing a computer to execute a process including: acquiring captured data of an image captured surface that is captured by an image capturer, a document, a first definition portion in which a first process that is performed on image data of an image of the document is defined, and a second definition portion in which a second process that differs from the first process is defined being placed on the image captured surface; and performing the first process that is defined in the first definition portion and the second process that is defined in the second definition portion on the image data of the document that is contained in the captured data that is acquired.

What is claimed is:

1. An information processing apparatus comprising:
a processor configured to:
acquire captured data of an image captured surface that is captured by an image capturer, a document, a first definition portion in which a first process that is performed on image data of an image of the document is defined, and a second definition portion in which a second process that differs from the first process is defined being placed on the image captured surface; and
perform the first process that is defined in the first definition portion and the second process that is defined in the second definition portion on the image data of the document that is contained in the captured data that is acquired.

2. The information processing apparatus according to claim 1,
wherein the first process is an image process, and the second process is an output process related to an output of the image data, and
wherein the processor is configured to:
perform the second process on the image data of the document on which the first process is performed.

3. The information processing apparatus according to claim 2,
wherein the processor is configured to:
acquire position information about a plurality of the second definition portions that is placed on the image captured surface; and
control an order in which a plurality of the second processes is performed depending on the position information that is acquired.

4. The information processing apparatus according to claim 3,
wherein the processor is configured to:
sequentially perform the plurality of the second processes each of which is defined in a corresponding one of the plurality of the second definition portions in order of increasing distance from a reference position on the image captured surface.

5. The information processing apparatus according to claim 1,
wherein the first definition portion and the second definition portion have different appearances.

6. The information processing apparatus according to claim 5,
wherein a plurality of the second definition portions that is placed on the image captured surface has different appearances, and
wherein a content of the second process that is defined on a surface of each of the plurality of the second definition portions is displayed.

7. A non-transitory computer readable medium storing a program causing a computer to execute a process comprising:
acquiring captured data of an image captured surface that is captured by an image capturer, a document, a first definition portion in which a first process that is performed on image data of an image of the document is defined, and a second definition portion in which a second process that differs from the first process is defined being placed on the image captured surface; and
performing the first process that is defined in the first definition portion and the second process that is defined in the second definition portion on the image data of the document that is contained in the captured data that is acquired.

8. A method comprising:
acquiring captured data of an image captured surface that is captured by an image capturer, a document, a first definition portion in which a first process that is performed on image data of an image of the document is defined, and a second definition portion in which a second process that differs from the first process is defined being placed on the image captured surface; and
performing the first process that is defined in the first definition portion and the second process that is defined in the second definition portion on the image data of the document that is contained in the captured data that is acquired.
